(19) United States
(12) Patent Application Publication
(10) Pub. No.: US 2009/0258100 A1
(43) Pub. Date: Oct. 15, 2009

(54) Thermal Growth Compensating Extrusion Screw Assembly

(75) Inventors: Edward Williams, St. Louis, MO (US); Alan Eugene Kirkland, Crystal City, MO (US)

Correspondence Address: STORM LLP, BANK OF AMERICA PLAZA, 901 MAIN STREET, SUITE 7100, DALLAS, TX, 75202, US

(73) Assignee: GOOD EARTH TOOLS, INC., Crystal City, MO (US)

(21) Appl. No.: 12/100,934

(22) Filed: Apr. 10, 2008

(51) Int. Cl. B29C 47/38

(52) U.S. Cl. 425/135; 425/200

(57) ABSTRACT

An improved extrusion assembly is disclosed which better adapts to thermal changes resultant from the transport of high-temperature extrudate. An extrusion screw present in the assembly includes a hollow portion. A biasing member is disposed in the hollow portion. When the assembly is transporting high-temperature extrudate, the biasing member's included Belleville washer component compensates for the thermal expansion and contraction of the extrusion screw.

### CROSS-REFERENCE TO RELATED APPLICATION

This application is related to co-pending patent application Ser. No. ______ filed ______ and entitled “Multi-Head Extruder Assembly,” which is incorporated by reference for all purposes.

### TECHNICAL FIELD

The invention relates generally to an extruder assembly, and, more particularly, to an assembly including an apparatus which compensates for thermal expansion and contraction of an extruder screw during use.

### BACKGROUND

Extrusion is a common step in the manufacturing process for a variety of goods. For example, in the manufacture of pet food, the food base is extruded through a die to form end product of a desired size. This extrusion is commonly accomplished by use of extruder assemblies. Such extruder assemblies typically are comprised of a motor, a housing, an extrusion screw, and a supportive structure. The motor causes the extrusion screw to rotate, forcing product along a path to a fixed destination. Some examples of conventional extruders are those of U.S. Pat. Nos. 2,946,089, 3,696,913 and 6,015,226.

### SUMMARY

The present invention or assembly, accordingly, provides an improved apparatus which better compensates for thermal expansion or contraction of an extruder screw in an extrusion assembly. The improved apparatus includes a housing and an extrusion screw disposed in the housing. At least a portion of the extrusion screw is hollow, the hollow portion communicating with an aperture formed in one end of the extrusion screw.

The apparatus also includes a race disposed in the housing. The race is adapted to support the extrusion screw in the housing. This race helps maintain the extrusion screw in a substantially fixed alignment. The apparatus uses a motor to rotate the extrusion screw in the housing.

The apparatus also includes a biasing member that extends through the aperture of the extrusion screw into the hollow portion of the extrusion screw. The biasing member is in mechanical communication with a bearing. The biasing member compensates for thermal growth of the extrusion screw while the extrusion assembly is in use. The biasing member includes a threaded rod, at least one resilient washer, at least one generally cylindrical resilient seal, and an end cap.

The threaded rod of the biasing member has a biasing end and an opposite threaded end. The threaded end extends through the aperture of the extrusion screw into the hollow portion of the extrusion screw. The biasing end is in mechanical communication with a bearing, the bearing being in mechanical communication with the race. The at least one resilient washer is generally conical in shape, such as a Belleville washer, and generally has an outer diameter less than the diameter of the hollow portion and aperture of the extrusion screw. The end cap and at least one resilient seal are both about the same diameter as the diameter of the hollow portion and aperture of the extrusion screw. The end cap, resilient washer, and resilient seal all surround the threaded rod, with at least one resilient seal being located between the end cap and the resilient washer.

Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional side view of an extrusion assembly in accordance with a preferred embodiment of the invention;

FIG. 2 is a cross-sectional side view of an extrusion screw in accordance with a preferred embodiment of the invention;

FIG. 3 is a cross-sectional side view of a portion of a biasing member in accordance with a preferred embodiment of the invention; and

FIG. 4 is an isometric view of a portion of a biasing member in accordance with a preferred embodiment of the invention.

### DETAILED DESCRIPTION

In the discussion of the FIGURES, the same reference numerals will be used throughout to refer to the same or similar components. Various components known to the art, such as extrusion devices and extruder die plates, have not been shown or discussed for the purpose of conciseness.

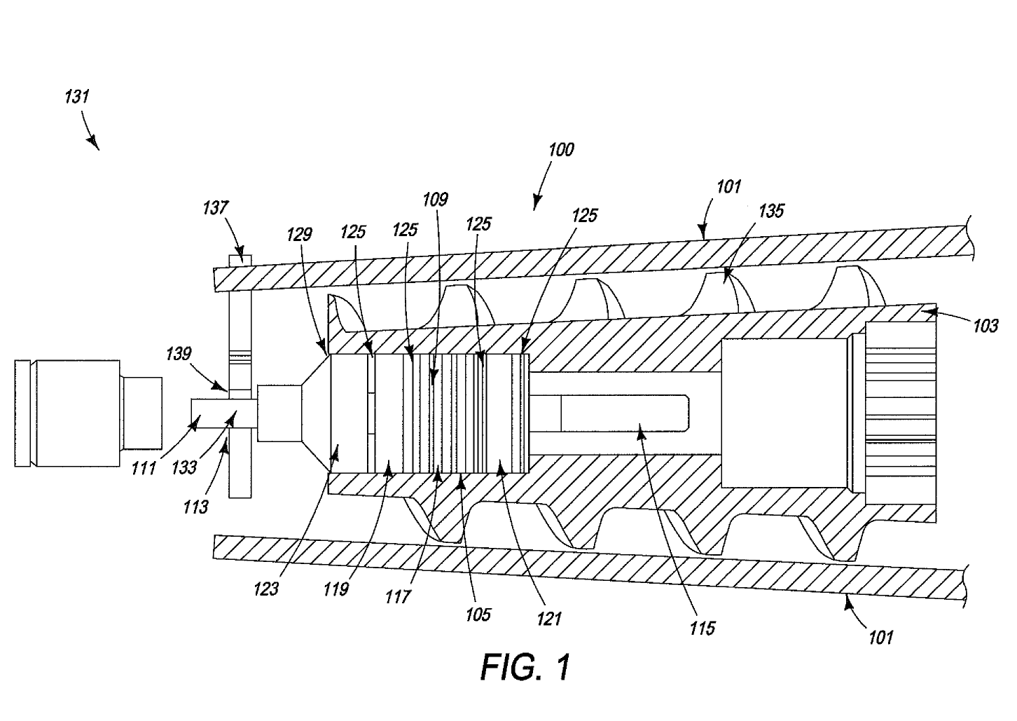

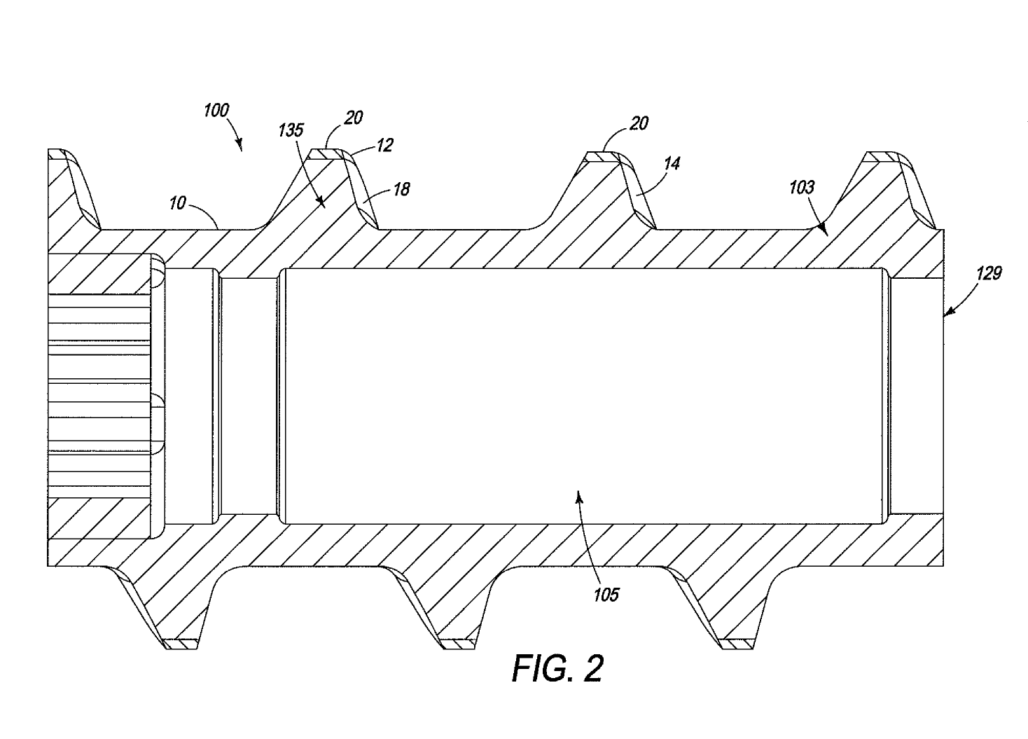

Referring to FIG. 1 and FIG. 2 of the drawings, the reference numeral 100 generally designates an extruder screw assembly in accordance with a preferred embodiment of the present invention. The assembly 100 includes a housing 101, an extrusion screw 103 disposed for rotation within housing 101, and a biasing member 109.

The exterior of the extrusion screw 103 includes a number of threads or flights 135 which, when the extrusion screw 103 is rotated, apply mechanical work to the extrudate, generating a flow in the direction of the terminal end 131 of the assembly 100. The extrusion screw 103 includes an aperture 129 formed in one end of the extrusion screw 103, which communicates with a hollow portion 105 of the extrusion screw 103, and is located proximate to the terminal end 131 of the assembly 100. The aperture 129 and the hollow portion 105 together form a bore or receptacle that allows for supporting components to be secured to the extrusion screw 103 with reduced interference with its generation of a flow of extrudate. Although not shown, a mandrel fits within the hollow portion 105 of the extrusion screw 103 and the biasing member 109 is secured to the mandrel by threaded rod 111. For most purposes, the mandrel can be considered part of extrusion screw 103.

A biasing member or spring 109 is dimensioned to fit inside the hollow portion 105 of the extrusion screw 103 to generally provide a seal for and support for the extrusion screw 103. The biasing member 109 includes a pair of resilient seals 119 and eight Belleville washers 117, which abut one another and are captured between an end cap 123 and an internal shoulder within the hollow portion 105 of the extrusion screw 103.

At the center of the biasing member 109 is the threaded rod 111, which includes a biasing end 113 and an opposite threaded end 115. The threaded end 115 is disposed inside and secured to the mandrel in the hollow portion 105 of the extrusion screw 103. The biasing end 113 is located outside of the extrusion screw 103 but still inside the housing 101, and includes a bearing surface 133 which is preferably formed of tungsten carbide. Bearing surface 133 generally operates to provide support for one end of the extrusion screw 103 by cooperating with three bearing points 139. These bearing points 139 are preferably comprised of tungsten carbide and are secured to the housing 101 by adjustable rods 137. Together, the bearing surface 133 and bearing points 139 are referred to as a bearing. This engagement between the bearing points 139 and bearing surface 133 provides support for maintaining the assembly in a desired alignment while permitting the rotation of the extrusion screw 103.

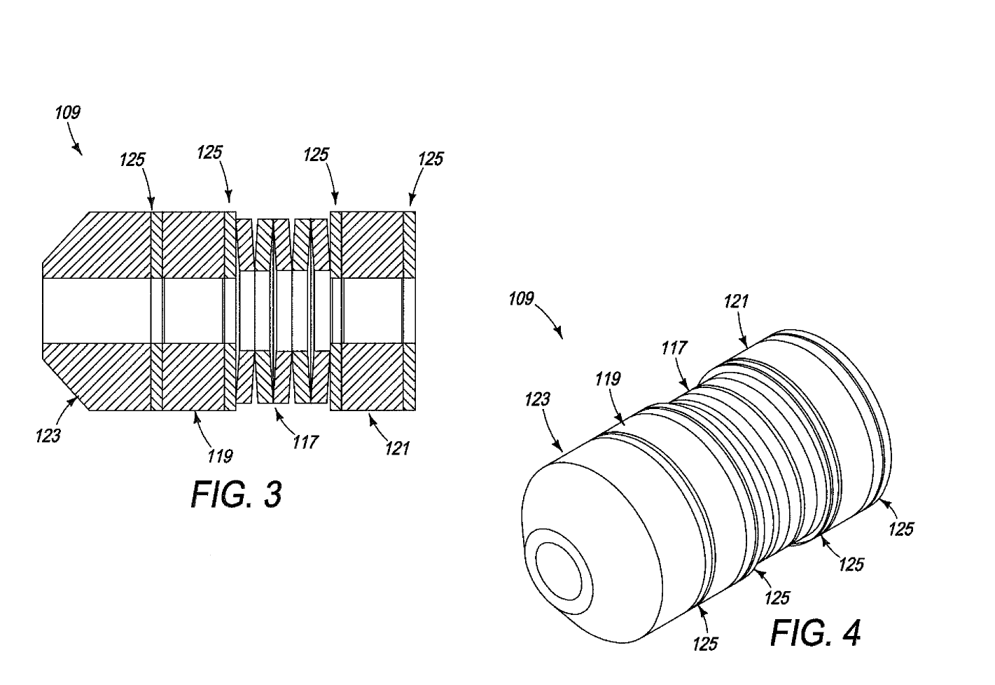

FIG. 3 and FIG. 4 of the drawings further illustrate a portion of the biasing member 109. Two resilient seals or discs 119 and 121 are depicted and are generally cylindrical in shape, having 3.255 inch outer diameter×1.065 inch inner diameter and, preferably, are comprised of TEFLON®. Extending through the aperture 129 is a generally frusto-conical end cap 123, where a portion of the end cap 123 is generally cylindrical in shape. The generally cylindrical portion of the end cap 123 is dimensioned for a sliding fit within the aperture 129 of the extrusion screw 103. The Belleville washers 117 are generally disposed between the resilient seals 119 and 121. A plurality of spacer washers 125 are provided and are generally disposed on both sides of each of the two resilient seals 119 and 121, which allows for a generally uniform force across the surface areas of each of the resilient seals 119 and 121. The Belleville washers 117 are arranged in a manner such that they oppositely face each other in order to provide longitudinal force, operating as a spring. The entire Belleville washers 117, resilient disc or seals 119 and 121, and spacer washers 125 assembly is axially confined or captured between end cap 123 and an internal shoulder in hollow portion 105 of the extrusion screw 103. Components 117, 119, 121, 123, and 125 of the biasing member 109 are generally resilient and can expand and contract in response to thermal expansion while maintaining a generally uniform longitudinal force. In other words, as extrusion screw 103 expands longitudinally as it heats, the expansion is accommodated by the biasing member 109, and resilient seals 119 and 121 are further compressed and radially expand to enhance their sealing capability.

As depicted in FIG. 1, and as stated above, the biasing member 109 provides a generally uniform axial or thrust force on the extrusion screw 103, regardless of thermal expansion or contraction effects. To accomplish this, Belleville washers 117 are compressed against the extrusion screw 103 within the hollow portion 105 of the extrusion screw 103. Resting next to the Belleville washers 117 are resilient seals 119 and 121. As compressive force is applied to each Belleville washer 117 (during assembly or in operation as a result of axial thermal expansion of the extrusion screw 103), the resilient seals 119 and 121 are compressed or “squeezed,” forcing the resilient seals 119 and 121 to expand radially in response to this pre-load. This provides a generally uniform fluid seal between at least a portion of the hollow portion 105 of the extrusion screw 103 and the exterior of the extrusion screw 103.

Providing the force to “squeeze” the resilient seals 119 and 121 are the Belleville washers 117 (which act as a spring) and another set of “squeezed” spacer washers 125. Biased against a spacer washer 125 is the end cap 123, which is secured to the extrusion screw 103 by the threaded rod 111 (which extends through other components comprising the biasing member 109). Thus, the threaded rod 111 can be secured to the extrusion screw 103, “squeezing” both resilient seals 119 and 121 to provide a generally uniform fluid seal between the hollow portion 105 of the extrusion screw 103 and the exterior of the extrusion screw 103, with little fear of the threaded rod 111 failing due to thermal expansion, because the Belleville washers 117 compensate for such expansion.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

I claim:

1. An extruder screw assembly, comprising:
a housing;
an extrusion screw that is disposed in the housing;
a bearing supporting the extrusion screw within the housing; and
a biasing member coupled between the bearing and the extrusion screw, wherein the biasing member compensates for thermal expansion or contraction of the screw.

2. The extruder screw assembly of claim 1, wherein the biasing member is disposed in an aperture formed in the extrusion screw.

3. The extruder screw assembly of claim 2, wherein the biasing member further comprises a plurality of Belleville washers, the Belleville washers surrounding a threaded rod extending through the aperture to secure the threaded rod to a mandrel.

4. The extruder screw assembly of claim 2, wherein the biasing member further comprises at least one resilient disc, the resilient disc surrounding a threaded rod extending through the aperture to secure the threaded rod to a mandrel.

5. The extruder screw assembly of claim 2, wherein the biasing member further comprises:
a threaded rod having a biasing end and an opposite threaded end, the threaded end extending through the aperture of the extrusion screw and connecting the extrusion screw to a mandrel, and the biasing end having a bearing extending therefrom, the bearing being in mechanical communication with the race;
an end cap secured to the threaded rod and disposed in the aperture of the extrusion screw;
a plurality of Belleville washers surrounding the threaded rod and retained on the threaded rod by the end cap; and
a resilient seal surrounding the threaded rod, the resilient seal being located between the end cap and the plurality of Belleville washers.

6. A resilient insert for a bore at the terminal end of an extruder screw, comprising:
a threaded rod having a biasing end and an opposite threaded end, the threaded end extending into the bore;
an end cap surrounding the threaded rod, the end cap being in communication with the biasing end of the threaded rod, and the end cap being adapted to be received in the bore;
at least one resilient washer, the washer having a generally conical shape and the washer surrounding the threaded rod; and
at least one resilient seal, the seal being cylindrical, and the seal surrounding the threaded rod, wherein the resilient seal is located between the resilient washer and the end cap.

7. The resilient insert of claim 6, wherein the resilient washer is a Belleville washer.

8. The resilient insert of claim 6, wherein the resilient seal is dimensioned to have a diameter that is about equal to the diameter of the bore.

9. The resilient insert of claim 6, wherein the outer diameter of the resilient washer is less than the diameter of the resilient seal.

10. The resilient insert of claim 9, wherein the insert further comprises a plurality of resilient washers that are arranged in pairs so that each pair of washers oppositely face each other.

11. The resilient insert of claim 6, wherein the threaded rod is of a length sufficient to extend through the resilient seal, the resilient washer, and the end cap.

12. An improved extruder screw assembly, comprising:
an extrusion screw having a first end and an opposite second end;
a bore formed in the first end of the extrusion screw;
a spring disposed in the bore;
an end cap retaining the spring in the bore; and
a resilient seal disposed between spring and the end cap.

13. The extruder screw assembly of claim 12, wherein the bore is cylindrical.

14. The extruder screw assembly of claim 13, wherein the spring comprises a plurality of Belleville washers.

15. The extruder screw assembly of claim 14, wherein the outer diameter of the Belleville washers is less than the diameter of the bore.

16. The extruder screw assembly of claim 12, wherein the spring and the end cap surround a threaded rod.

17. The extruder screw assembly of claim 12, wherein the resilient seal comprises at least one elastomer seal disc.
